(19) United States
(12) Patent Application Publication
(10) Pub. No.: US 2020/0279264 A1
(43) Pub. Date: Sep. 3, 2020

(54) WITHDRAWAL REQUEST REVIEW METHOD, APPARATUS, ELECTRONIC DEVICE AND STORAGE MEDIUM

(71) Applicant: Hong Kong LiveMe Corporation Limited, Hong Kong (CN)

(72) Inventor: Xiliang BAI, Cayman Islands (GB)

(21) Appl. No.: 16/645,604

(22) PCT Filed: Aug. 2, 2018
(86) PCT No.: PCT/CN2018/098287

§ 371 Date: Mar. 9, 2020

(30) Foreign Application Priority Data
Sep. 11, 2017 (CN) 201710811199.X

(51) Int. Cl. G06Q 20/40; G06Q 20/06; G06Q 40/04

(52) U.S. Cl. CPC G06Q 20/405; G06Q 40/04; G06Q 20/0655

(57) ABSTRACT

A method and apparatus for auditing a withdrawal request, an electronic device and a storage medium are provided. The method includes: obtaining at least one to-be-audited withdrawal request (S110); extracting a withdrawal account from each of the at least one withdrawal request (S120), and generating one withdrawal record corresponding to this withdrawal account by merging withdrawal data items in a plurality of withdrawal requests having the same withdrawal account respectively; for each withdrawal record, reading withdrawal data items in the withdrawal record (S140); matching the read withdrawal data items with pre-stored audit rules (S150); and determining that a withdrawal record having withdrawal data items that successfully match the pre-stored audit rules passes audit (S160). By using the method, the workload of the operating personnel in the process for auditing the withdrawal requests can be reduced.

The present application claims the priority to a Chinese Patent Application No. 201710811199.X, filed with the China National Intellectual Property Administration on Sep. 11, 2017, and entitled “WITHDRAWAL REQUEST REVIEW METHOD, APPARATUS, ELECTRONIC DEVICE AND STORAGE MEDIUM”, which is incorporated herein by reference in its entirety.

### TECHNICAL FIELD

The present application relates to the field of network transaction technology, and in particular, to a method and apparatus for auditing a withdrawal request, an electronic device and a storage medium.

### BACKGROUND

In the real life, some network APPs (Applications) are usually provided with withdrawal functions. The withdrawal functions refer to functions that the network APPs employ virtual currency to implement network transactions between users, and upon the users obtain the virtual currency, the users may also exchange the virtual currency into real currency, and withdraw the real currency.

In the prior art, when a user withdraws the real currency, the user needs to submit a withdrawal request through a withdrawal button on a network APP. Then, an operating personnel of the network APP manually audits various to-be-audited parameters (for example, a withdrawal amount of currency, a bank account, etc.) in the withdrawal request, and the withdrawal can be successful only for the withdrawal request that pass the audit.

Since the withdrawal request is audited manually in the prior art, the operating personnel needs to audit each withdrawal request. In the real life, it always happens that one user submits multiple withdrawal requests. In this case, the operating personnel still needs to separately audit each of the withdrawal requests submitted by the user, which causes increased effort of the operating personnel in the audit process.

### SUMMARY

The object of the present application is to provide a method and apparatus for auditing a withdrawal request, an electronic device and a storage medium, to reduce the workload of the operating personnel in the process for auditing withdrawal requests.

To achieve the object described above, an embodiment of the present application provides a method for auditing a withdrawal request, which is applied to an electronic device. The method includes:

obtaining at least one to-be-audited withdrawal request;

extracting a withdrawal account from each of the at least one withdrawal request;

determining a first-type withdrawal account(s) and a second-type withdrawal account(s); for each first-type withdrawal account, determining a withdrawal request having the first-type withdrawal account as one withdrawal record corresponding to the first-type withdrawal account; for each second-type withdrawal account, merging withdrawal data items in a plurality of withdrawal requests having the second-type withdrawal account, respectively, to generate one withdrawal record corresponding to the second-type withdrawal account; wherein, the first-type withdrawal account is a withdrawal account which is only included in one withdrawal request, and the second-type withdrawal account is a withdrawal account which is included in a plurality of withdrawal requests;

for each withdrawal record, reading withdrawal data items in the withdrawal record;

matching the read withdrawal data items with pre-stored audit rules; and

determining that a withdrawal record having withdrawal data items that successfully match the pre-stored audit rules passes audit.

In a specific implementation provided by an embodiment of the present application, the step of obtaining at least one to-be-audited withdrawal request includes:

obtaining at least one to-be-audited withdrawal request that is received within a predetermined time period.

In a specific implementation provided by an embodiment of the present application, after extracting the withdrawal account from each of the at least one withdrawal request and before determining the first-type withdrawal account(s) and the second-type withdrawal account(s), the method further includes:

determining a withdrawal request with a withdrawal account containing a preset identifier as a first withdrawal request;

the step of: for each first-type withdrawal account, determining a withdrawal request having the first-type withdrawal account as one withdrawal record corresponding to the first-type withdrawal account; for each second-type withdrawal account, merging withdrawal data items in a plurality of withdrawal requests having the second-type withdrawal account respectively, to generate one withdrawal record corresponding to the second-type withdrawal account, includes:

for each first-type withdrawal account, determining a first withdrawal request having the first-type withdrawal account as one withdrawal record corresponding to the first-type withdrawal account; for each second-type withdrawal account, merging withdrawal data items in a plurality of first withdrawal requests having the second-type withdrawal account respectively, to generate one withdrawal record corresponding to the second-type withdrawal account.

In a specific implementation provided by an embodiment of the present application, the withdrawal data items include an amount of withdrawn virtual currency this time, an accumulated amount of received virtual currency, an accumulated amount of exchanged virtual currency, an amount of remaining virtual currency after withdrawal, an accumulated amount of withdrawn virtual currency and an error adjustment amount of virtual currency;

the step of: for each withdrawal record, reading withdrawal data items in the withdrawal record includes:

for each withdrawal record, reading the amount of withdrawn virtual currency this time, the accumulated amount of received virtual currency, the accumulated amount of exchanged virtual currency, the amount of remaining virtual currency after withdrawal, the accumulated amount of withdrawn virtual currency and the error adjustment amount of virtual currency in the withdrawal record;

the step of matching the read withdrawal data items with pre-stored audit rules includes:

determining whether the amount of withdrawn virtual currency this time is larger than a preset threshold amount of withdrawn virtual currency;

if the amount of withdrawn virtual currency this time is not larger than the preset threshold amount of withdrawn virtual currency, determining that the amount of withdrawn virtual currency this time successfully matches the pre-stored audit rules;

if the amount of withdrawn virtual currency this time is larger than the preset threshold amount of withdrawn virtual currency, determining that the amount of withdrawn virtual currency this time fails to match the pre-stored audit rules;

calculating a sum of the accumulated amount of exchanged virtual currency, the amount of remaining virtual currency after withdrawal, the accumulated amount of withdrawn virtual currency, the error adjustment amount of virtual currency and the amount of withdrawn virtual currency this time;

determining whether the sum is equal to the accumulated amount of received virtual currency;

if the sum is equal to the accumulated amount of received virtual currency, determining that the accumulated amount of received virtual currency, the accumulated amount of exchanged virtual currency, the amount of remaining virtual currency after withdrawal, the accumulated amount of withdrawn virtual currency and the error adjustment amount of virtual currency successfully match with the pre-stored audit rules, respectively;

if the sum is not equal to the accumulated amount of received virtual currency, determining that the accumulated amount of received virtual currency, the accumulated amount of exchanged virtual currency, the amount of remaining virtual currency after withdrawal, the accumulated amount of withdrawn virtual currency and the error adjustment amount of virtual currency fail to match the pre-stored audit rules respectively.

In an implementation provided by an embodiment of the present application, each generated withdrawal record is stored in a preset withdrawal record table;

the step of determining that a withdrawal record having withdrawal data items that successfully match the pre-stored audit rules passes audit includes:

adding a pass audit identifier in the withdrawal record table for the withdrawal record having the withdrawal data items that successfully match the pre-stored audit rules.

In an implementation provided by an embodiment of the present application, after matching the read withdrawal data items with the pre-stored audit rules, the method further includes: for a withdrawal record having withdrawal data items that fail to match the pre-stored audit rules, adding content information about match failure in the withdrawal record table; outputting the withdrawal record table;

receiving a modification made by an operating personnel for the withdrawal record having the content information about match failure, to obtain a final withdrawal record table;

sending the final withdrawal record table to a payment system via a preset interface communicating with the payment system.

In an implementation provided by an embodiment of the present application, the step of receiving a modification made by an operating personnel for the withdrawal record having the content information about match failure, to obtain a final withdrawal record table includes:

receiving the modification made by the operating personnel for the withdrawal record having the content information about match failure;

extracting the withdrawal data required by the payment system from the modified withdrawal record table to generate the final withdrawal record table.

An embodiment of the present application further provides an apparatus for auditing a withdrawal request, which is applied to an electronic device. The apparatus includes:

a first obtaining module, configured for: obtaining at least one to-be-audited withdrawal request:

an extracting module, configured for: extracting a withdrawal account from each of the at least one withdrawal request;

a merging module, configured for: determining a first-type withdrawal account(s) and a second-type withdrawal account(s); for each first-type withdrawal account, determining a withdrawal request having the first-type withdrawal account as one withdrawal record corresponding to the first-type withdrawal account; for each second-type withdrawal account, merging withdrawal data items in a plurality of withdrawal requests having the second-type withdrawal account, respectively, to generate one withdrawal record corresponding to the second-type withdrawal account; wherein, the first-type withdrawal account is a withdrawal account which is only included in one withdrawal request, and the second-type withdrawal account is a withdrawal account which is included in a plurality of withdrawal requests;

a reading module, configured for: for each withdrawal record, reading withdrawal data items in the withdrawal record;

a matching module, configured for: matching the read withdrawal data items with pre-stored audit rules; and

a first determination module, configured for: determining that a withdrawal record having withdrawal data items that successfully match the pre-stored audit rules passes audit.

In an implementation provided by an embodiment of the present application, the obtaining module is further configured for: obtaining at least one to-be-audited withdrawal request that is received within a predetermined time period.

In a specific implementation provided by an embodiment of the present application, the apparatus further includes:

a second determination module, configured for: determining a withdrawal request with a withdrawal account containing a preset identifier as a first withdrawal request;

the merging module is further configured for: determining the first-type withdrawal account(s) and the second-type withdrawal account(s): for each first-type withdrawal account, determining a first withdrawal request having the first-type withdrawal account as one withdrawal record corresponding to the first-type withdrawal account; for each second-type withdrawal account, merging withdrawal data items in a plurality of first withdrawal requests having the second-type withdrawal account respectively, to generate one withdrawal record corresponding to the second-type withdrawal account.

In a specific implementation provided by an embodiment of the present application, the withdrawal data items include an amount of withdrawn virtual currency this time, an accumulated amount of received virtual currency, an accumulated amount of exchanged virtual currency, an amount of remaining virtual currency after withdrawal, an accumulated amount of withdrawn virtual currency and an error adjustment amount of virtual currency;

the reading module is further configured for: for each withdrawal record, reading the amount of withdrawn virtual currency this time, the accumulated amount of received virtual currency, the accumulated amount of exchanged virtual currency, the amount of remaining virtual currency after withdrawal, the accumulated amount of withdrawn virtual currency and the error adjustment amount of virtual currency in the withdrawal record;

the matching module includes:

a first judgment unit, configured for: determining whether the amount of withdrawn virtual currency this time is larger than a preset threshold amount of withdrawn virtual currency;

a first determining unit, configured for: when the first judgment unit determines that the amount of withdrawn virtual currency this time is not larger than the preset threshold amount of withdrawn virtual currency, determining that the amount of withdrawn virtual currency this time successfully matches the pre-stored audit rules:

a second determining unit, configured for: when the first judgment unit determines that the amount of withdrawn virtual currency this time is larger than the preset threshold amount of withdrawn virtual currency, determining that the amount of withdrawn virtual currency this time fails to match the pre-stored audit rules;

a summing unit, configured for: calculating a sum of the accumulated amount of exchanged virtual currency, the amount of remaining virtual currency after withdrawal, the accumulated amount of withdrawn virtual currency, the error adjustment amount of virtual currency and the amount of withdrawn virtual currency this time;

a second judgment unit, configured for: determining whether the sum is equal to the accumulated amount of received virtual currency;

a third determining unit, configured for: when the second judgment unit determines that the sum is equal to the accumulated amount of received virtual currency, determining that the accumulated amount of received virtual currency, the accumulated amount of exchanged virtual currency, the amount of remaining virtual currency after withdrawal, the accumulated amount of withdrawn virtual currency and the error adjustment amount of virtual currency successfully match with the pre-stored audit rules, respectively:

a fourth determining unit, configured for: when the second judgment unit determines that the sum is not equal to the accumulated amount of received virtual currency, determining that the accumulated amount of received virtual currency, the accumulated amount of exchanged virtual currency, the amount of remaining virtual currency after withdrawal, the accumulated amount of withdrawn virtual currency and the error adjustment amount of virtual currency fail to match the pre-stored audit rules respectively.

In an implementation provided by an embodiment of the present application, each generated withdrawal record is stored in a preset withdrawal record table:

the first determination module is further configured for: adding a pass audit identifier in the withdrawal record table for the withdrawal record having the withdrawal data items that successfully match the pre-stored audit rules.

In a specific implementation provided by an embodiment of the present application, the apparatus further includes:

an adding module, configured for: for a withdrawal record having withdrawal data items that fail to match the pre-stored audit rules, adding content information about match failure in the withdrawal record table;

an outputting module, configured for: outputting the withdrawal record table:

a second obtaining module, configured for: receiving a modification made by an operating personnel for the withdrawal record having the content information about match failure, to obtain a final withdrawal record table;

a sending module, configured for: sending the final withdrawal record table to a payment system via a preset interface communicating with the payment system.

In a specific implementation provided by an embodiment of the present application, the second obtaining module includes:

a receiving unit, configured for: receiving the modification made by the operating personnel for the withdrawal record having the content information about match failure;

an extracting unit, configured for: extracting the withdrawal data required by the payment system from the modified withdrawal record table to generate the final withdrawal record table.

An embodiment of the present application further provides an electronic device, including a processor, a communication interface, a memory and a communication bus, wherein, the processor, the communication interface and the memory communicate with each other via the communication bus;

the memory is configured for: storing a computer program;

the processor is configured for: when executing the computer program stored in the memory, implementing the method.

An embodiment of the present application further provides a computer-readable storage medium. The computer-readable storage medium stores a computer program therein, and the computer program, when executed by a processor, implements any of the above methods for auditing a withdrawal request.

An embodiment of the present application further provides a computer program product including instructions. The computer program product is executed by an electronic device, so as to cause the electronic device to perform any one of the above methods for auditing a withdrawal request.

In the method and apparatus for auditing a withdrawal request, the electronic device and the storage medium provided by embodiments of the present application, at least one to-be-audited withdrawal request is obtained; a withdrawal account is extracted from each of the at least one withdrawal request; a first-type withdrawal account(s) and a second-type withdrawal account(s) are determined; for each first-type withdrawal account, a withdrawal request having the first-type withdrawal account is determined as one withdrawal record corresponding to the first-type withdrawal account; for each second-type withdrawal account, withdrawal data items in a plurality of withdrawal requests having the second-type withdrawal account are merged respectively, to generate one withdrawal record corresponding to the second-type withdrawal account: wherein, the first-type withdrawal account is a withdrawal account which is only included in one withdrawal request, and the second-type withdrawal account is a withdrawal account which is included a plurality of withdrawal requests; for each withdrawal record, withdrawal data items in the withdrawal record are read: the read withdrawal data items are matched with pre-stored audit rules: and it is determined that a withdrawal record having withdrawal data items that successfully match the pre-stored audit rules passes audit.

In the embodiments of the present application, after obtaining at least one to-be-audited withdrawal request, the electronic device can merge the withdrawal requests having the same withdrawal account into one withdrawal record, which reduces the number of withdrawal requests that needs to be audited, implements batched audit of withdrawal requests, and thus reduces the workload of the operating personnel in the process of auditing withdrawal requests.

### BRIEF DESCRIPTION OF THE DRAWINGS

In order to more clearly describe the technical solutions of the embodiments of the present application or of the prior art, drawings that need to be used in embodiments and the prior art will be briefly described below. Obviously, the drawings described below are for only some of embodiments of the present application; those skilled in the art can also obtain other drawings based on these drawings without any creative efforts.

FIG. 1a is a first flowchart of a method for auditing a withdrawal request according to an embodiment of the present application.

FIG. 1b is a flowchart of a specific implementation for matching read withdrawal data items with pre-stored audit rules in the embodiment shown in FIG. 1a.

FIG. 2a is a second flowchart of a method for auditing a withdrawal request according to an embodiment of the present application.

FIG. 2b is a first diagram of a withdrawal record table used in the embodiment shown in FIG. 2a.

FIG. 2c is a second diagram of a withdrawal record table used in the embodiment shown in FIG. 2a.

FIG. 3 is a schematic structural diagram of an apparatus for auditing a withdrawal request according to an embodiment of the present application;

FIG. 4 is a schematic structural diagram of an electronic device according to an embodiment of the present application.

### DETAILED DESCRIPTION

The technical solutions in the embodiments of the present application will be clearly and completely described below with reference to the drawings in the embodiments of the present application. Obviously, the described embodiments are only some, and not all, of the embodiments of the present application. All other embodiments obtained based on the embodiments of the present application by those skilled in the art without any creative efforts fall into the scope of protection defined by the present application.

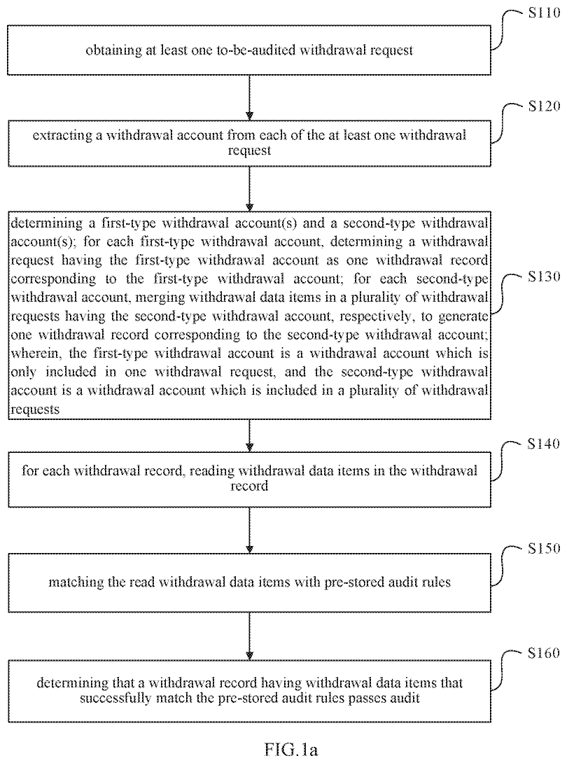

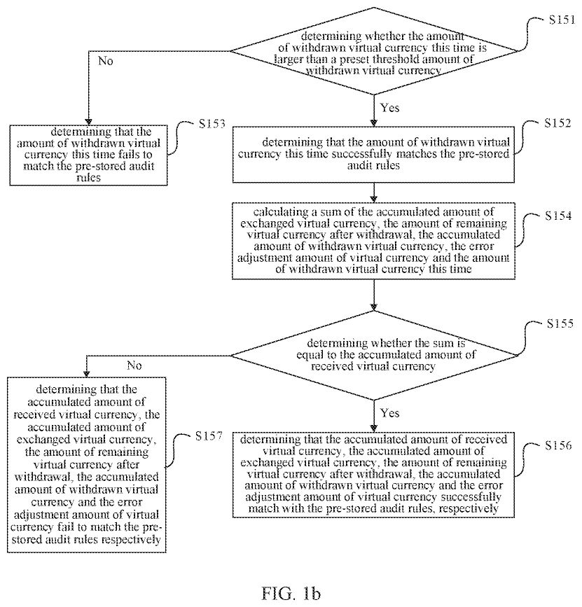

To achieve the object mentioned above, an embodiment of the present application provides a method for auditing a withdrawal request, which may be applied to an electronic device. FIG. 1a is a first flowchart of a method for auditing a withdrawal request according to an embodiment of the present application. The method includes the following steps S110-S160.

At S110, at least one to-be-audited withdrawal request is obtained.

In a specific implementation provided by an embodiment of the present application, the step S110 includes: obtaining at least one to-be-audited withdrawal request that is received within a predetermined time period.

For example, a user uses a network APP (for example, a live streaming APP) with a withdrawal function. When the user uses the withdrawal function, the network APP generates a withdrawal request, and sends the same to an electronic device. The electronic device receives the withdrawal request sent from the network APP, and stores the withdrawal request to be audited. The withdrawal request may include a sending time, and the electronic device may store the withdrawal request based on the sending time of the withdrawal request. When an auditor needs to audit withdrawal requests of a certain date, the electronic device obtains to-be-audited withdrawal requests received during the date and performs the subsequent step S120. This is a way convenient for an auditor to query and audit the withdrawal requests.

In other implementations, the electronic device may continuously receive withdrawal requests sent by the network APP and store them. When the number of the received requests reaches a predetermined threshold (for example, 100), the electronic device performs the subsequent step S120.

At S120, a withdrawal account is extracted from each of the at least one withdrawal request.

Specifically, the withdrawal request includes a withdrawal account. As an identifier of the withdrawal request, the withdrawal account represents a user who sends the withdrawal request. After obtaining the at least one to-be-audited withdrawal request, the electronic device extracts, from each of the at least one to-be-audited withdrawal request, a withdrawal account of the withdrawal request.

At S130, a first-type withdrawal account and a second-type withdrawal account are determined: for each first-type withdrawal account, a withdrawal request having the first-type withdrawal account is determined as a withdrawal record corresponding to the first-type withdrawal account; for each second-type withdrawal account, all withdrawal data items in a plurality of withdrawal requests having the second-type withdrawal account are merged respectively, to generate a withdrawal record corresponding to the second-type withdrawal account: wherein, the first-type withdrawal account is a withdrawal account which is only included in one withdrawal request, and the second-type withdrawal account is a withdrawal account which is included in a plurality of withdrawal requests.

Specifically, the obtained withdrawal requests may include one withdrawal request in which a certain withdrawal account is only included, that is, a withdrawal request that includes the withdrawal account different from withdrawal accounts included in the other withdrawal requests. The obtained withdrawal requests may also include a plurality of withdrawal requests having the same withdrawal account. The electronic device determines a withdrawal account which is only included in one withdrawal request as the first-type withdrawal account, and determines a withdrawal account which is included in the plurality of withdrawal requests as the second-type withdrawal account.

By way of example, it is assumed that the electronic device obtains three withdrawal requests, including one withdrawal request with a withdrawal account of 123@qq.com, and two withdrawal requests with a withdrawal account of 456@qq.com. 123@qq.com is determined as the first-type withdrawal account, and 456@qq.com is determined as the second-type withdrawal account. The electronic device may directly determine one withdrawal request with the withdrawal account of 123@qq.com as one withdrawal record corresponding to the first-type withdrawal account of 123@qq.com. The electronic device merges all withdrawal data items in the two withdrawal requests with the withdrawal account of 456@qq.com respectively, to generate one withdrawal record corresponding to the second-type withdrawal account of 456@qq.com.

In the embodiment, withdrawal data in a withdrawal request may only include an amount of withdrawn virtual currency this time, and may further includes an accumulated amount of received virtual currency, an accumulated amount of exchanged virtual currency, an amount of remaining virtual currency after withdrawal, an accumulated amount of withdrawn virtual currency, an error adjustment amount of virtual currency, a bank account, a duration of a user using an APP, the number of a user using an APP, and so on.

In order to merge a plurality of withdrawal requests having the same withdrawal account, it is required to merge all withdrawal data items in the withdrawal requests, respectively. For example, a result obtained by summing the amount of withdrawn virtual currency this time in all of the withdrawal requests may be used as the amount of withdrawn virtual currency this time for the generated withdrawal record. A bank account in any one of the withdrawal requests may be used as the bank account for the generated withdrawal record.

In the implementation provided by an embodiment of the present application, in order to facilitate the merging of the withdrawal requests, the electronic device may pre-store withdrawal data items of all users that use the network APP. Except for withdrawal data to be calculated (for example, the amount of withdrawn virtual currency this time), the other withdrawal data may be directly obtained and used as corresponding withdrawal data in the generated withdrawal record.

At S140, for each withdrawal record, withdrawal data items in the withdrawal record are read.

By way of example, it is assumed that 80 withdrawal records are finally obtained. The electronic device reads the withdrawal data items in each of the 80 withdrawal records respectively.

At S150, the read withdrawal data items are matched with pre-stored audit rules.

Specifically, the electronic device pre-stores an audit rule for each item of withdrawal data. After reading withdrawal data items in a certain withdrawal record, the electronic device matches each item of withdrawal data with an audit rule for the item of withdrawal data.

In another embodiment, the electronic device may be a server, and the pre-stored audit rules may be stored in a database of the server.

At S160, it is determined that a withdrawal record having the withdrawal data items that successfully match the pre-stored audit rules passes audit.

Specifically, when each item of withdrawal data in a certain withdrawal record successfully matches an audit rule for the item of withdrawal data, it is determined that the withdrawal record passes the audit.

By way of example, it is assumed that a withdrawal record includes six withdrawal data items in total, i.e., the amount of withdrawn virtual currency this time, the accumulated amount of received virtual currency, the accumulated amount of exchanged virtual currency, the amount of remaining virtual currency after withdrawal, the accumulated amount of withdrawn virtual currency and the error adjustment amount of virtual currency. When these six withdrawal data items are matched with their corresponding audit rules, and these six withdrawal data items successfully matches the corresponding audit rules, respectively, it is determined that the withdrawal record passes the audit.

In the method for auditing a withdrawal request provided by the embodiment of the present application, after obtaining at least one to-be-audited withdrawal request, the electronic device can merge the withdrawal requests having the same withdrawal account into one withdrawal record, which reduces the number of withdrawal requests that needs to be audited, implements batched audit of withdrawal requests, and thus reduces the workload of the operating personnel in the process of auditing withdrawal requests.

It should be noted that the process from step S110 to step S160 is an automatically audit process of the electronic device without manual intervention. Furthermore, a plurality of withdrawal requests can be audited once in the process, which reduces the audit cycle, accelerates the audit process, improves the work efficiency, improves the timeliness of the withdrawal process, and thus can improve the user experience.

In some cases, withdrawal accounts in the withdrawal requests obtained by the electronic device may be invalid. In order to select withdrawal requests with valid withdrawal accounts, a specific implementation provided by an embodiment of the present application is as follows.

After the step of extracting a withdrawal account from each of the at least one obtained withdrawal request and before the step S130, the method further includes:

determining a withdrawal request with a withdrawal account including a preset identifier as a first withdrawal request.

Specifically, in order to determine whether a withdrawal account is valid, it may be determined whether the withdrawal account includes a preset identifier. If the withdrawal account includes a preset identifier, the withdrawal account is determined to be valid, and then the withdrawal account is determined as the first withdrawal request, and if the withdrawal account does not includes a preset identifier, the withdrawal account is determined to be invalid.

In the embodiment, the preset identifier may be “@” or “.com”, etc.

The step 130 includes:

determining a first-type withdrawal account and a second-type withdrawal account; for each first-type withdrawal account, determining the first withdrawal request having the first-type withdrawal account as one withdrawal record corresponding to the first-type withdrawal account; for each second-type withdrawal account, merging withdrawal data items in a plurality of first withdrawal requests having the second-type withdrawal account, respectively, to generate one withdrawal record corresponding to the second-type withdrawal account.

Specifically, all first withdrawal requests are withdrawal requests that include valid withdrawal accounts. The first withdrawal request having the first-type withdrawal account is determined as one withdrawal record corresponding to the first-type withdrawal account, so that each of the obtained withdrawal records includes a valid first-type withdrawal account. The withdrawal data items in a plurality of the first withdrawal requests having the second-type withdrawal account are merged respectively to generate one withdrawal record corresponding to the second-type withdrawal account, such that each of the obtained withdrawal records includes a valid second-type withdrawal account.

In the embodiment of the present application, it may be determined whether a withdrawal account is valid through another method. Specifically, when a user uses a network APP, the user will register a withdrawal account. The electronic device may store all withdrawal accounts registered by users that use the network APP. After obtaining a withdrawal account in a to-be-audited withdrawal request, the electronic device searches for the withdrawal account among all stored withdrawal accounts; if the withdrawal account in the to-be-audited withdrawal request has been stored, the electronic device determines that the withdrawal account is valid, and if the withdrawal account in the to-be-audited withdrawal request hasn't been stored, the electronic device determines that the withdrawal account is invalid.

In a specific implementation provided by an embodiment of the present application, the withdrawal data items include the amount of withdrawn virtual currency this time, the accumulated amount of received virtual currency, the accumulated amount of exchanged virtual currency, the amount of remaining virtual currency after withdrawal, the accumulated amount of withdrawn virtual currency and the error adjustment amount of virtual currency.

The step of, for each withdrawal record, reading withdrawal data items in the withdrawal record includes:

for each withdrawal record, reading the amount of withdrawn virtual currency this time, the accumulated amount of received virtual currency, the accumulated amount of exchanged virtual currency, the amount of remaining virtual currency after withdrawal, the accumulated amount of withdrawn virtual currency and the error adjustment amount of virtual currency in the withdrawal record.

In the embodiment, the amount of withdrawn virtual currency this time refers to the amount of virtual currency that is to be withdrawn by a user this time. The accumulated amount of received virtual currency refers to the total amount of virtual currency received by a user starting from the use of the network APP before the generation of the withdrawal record this time. The accumulated amount of exchanged virtual currency refers to the total amount of all virtual currency exchanged by a user starting from the use of the network APP before the generation of the withdrawal record. The amount of remaining virtual currency after withdrawal refers to the total amount of remaining virtual currency after a user withdraws virtual currency this time. The accumulated amount of withdrawn virtual currency refers to the total amount of all virtual currency withdrawn by a user starting from the use of the network APP before the generation of the withdrawal record this time. The error adjustment amount of virtual currency refers to the amount of error virtual currency that possibly present in the withdrawal process this time.

FIG. 1b is a flowchart of a specific implementation for matching the read withdrawal data items with pre-stored audit rules in the embodiment shown in FIG. 1a, which includes steps S151-S157.

At S151, it is determined whether the amount of withdrawn virtual currency this time is larger than a preset threshold amount of withdrawn virtual currency; if the amount of withdrawn virtual currency this time is not larger than the preset threshold amount of withdrawn virtual currency, a step S153 is performed; and if the amount of withdrawn virtual currency this time is larger than the preset threshold amount of withdrawn virtual currency, a step S152 is performed.

In the embodiment, the threshold amount of withdrawn virtual currency may be set as a fixed value, for example, the threshold amount of withdrawn virtual currency may be 1000. The threshold amount of withdrawn virtual currency may also be set based on the number of withdrawal requests that are merged into a withdrawal record, for example, if the number of withdrawal requests that are merged into a withdrawal record is 3, the threshold amount of withdrawn virtual currency may be 3000.

At S152, it is determined that the amount of withdrawn virtual currency this time successfully matches the pre-stored audit rules.

At S153, it is determined that the amount of withdrawn virtual currency this time fails to match the pre-stored audit rules.

Specifically, the threshold amount of withdrawn virtual currency is a criterion to determine whether the amount of withdrawn virtual currency this time is large or small. When the amount of withdrawn virtual currency this time is not larger than the preset threshold amount of withdrawn virtual currency, it is indicated that the amount of withdrawn virtual currency this time is small, and then it is determined that the amount of withdrawn virtual currency this time successfully matches the pre-stored audit rule. When the amount of withdrawn virtual currency this time is larger than the preset threshold amount of withdrawn virtual currency, it is indicated that the amount of withdrawn virtual currency this time is large, and then it is determined that the amount of withdrawn virtual currency this time fails to match the pre-stored audit rule.

At S154, a sum of the accumulated amount of exchanged virtual currency, the amount of remaining virtual currency after withdrawal, the accumulated amount of withdrawn virtual currency, the error adjustment amount of virtual currency and the amount of withdrawn virtual currency this time is calculated.

In the embodiment, the steps S154 to S157 may be performed after it is determined that the amount of withdrawn virtual currency this time successfully matches the pre-stored audit rules.

Specifically, the electronic device calculates a sum of the accumulated amount of exchanged virtual currency, the amount of remaining virtual currency after withdrawal, the accumulated amount of withdrawn virtual currency, the error adjustment amount of virtual currency and the amount of withdrawn virtual currency this time that are read from a withdrawal record.

At S155, it is determined whether the sum is equal to the accumulated amount of received virtual currency; if the sum is equal to the accumulated amount of received virtual currency, a step S156 is performed; and if the sum is not equal to the accumulated amount of received virtual currency, a step S157 is performed.

Specifically, after obtaining the sum, the electronic device compares the sum with the accumulated amount of received virtual currency, to determine whether the sum is equal to the accumulated amount of received virtual currency. If the sum is equal to the accumulated amount of received virtual currency, it is indicated that the withdrawal data items in the withdrawal record represent a balance of payment, and if the sum is not equal to the accumulated amount of received virtual currency, it is indicated that the withdrawal data items in the withdrawal record represent an imbalance of payment.

At S156, it is determined that the accumulated amount of received virtual currency, the accumulated amount of exchanged virtual currency, the amount of remaining virtual currency after withdrawal, the accumulated amount of withdrawn virtual currency and the error adjustment amount of virtual currency successfully match the pre-stored audit rules, respectively.

At S157, it is determined that the accumulated amount of received virtual currency, the accumulated amount of exchanged virtual currency, the amount of remaining virtual currency after withdrawal, the accumulated amount of withdrawn virtual currency and the error adjustment amount of virtual currency fail to match the pre-stored audit rules, respectively.

Specifically, if the sum is equal to the accumulated amount of received virtual currency, the withdrawal data items in the withdrawal record represent a balance of payment. At this time, it is determined that the accumulated amount of received virtual currency, the accumulated amount of exchanged virtual currency, the amount of remaining virtual currency after withdrawal, the accumulated amount of withdrawn virtual currency and the error adjustment amount of virtual currency successfully matches the pre-stored audit rules respectively. If the sum is not equal to the accumulated amount of received virtual currency, the withdrawal data items in the withdrawal record represent an imbalance of payment. At this time, it is determined that the accumulated amount of received virtual currency, the accumulated amount of exchanged virtual currency, the amount of remaining virtual currency after withdrawal, the accumulated amount of withdrawn virtual currency and the error adjustment amount of virtual currency fail to match the pre-stored audit rules respectively.

In a further implementation provided by an embodiment of the present application, the withdrawal data items in the withdrawal record may further include a bank account. The bank account refers to a bank account bound with a withdrawal account when a user registers the withdrawal account. When the user sends a withdrawal request by the network APP, the operator may make a payment for the bank account.

The electronic device may store all withdrawal accounts and bank accounts correspondingly. After reading a bank account from a certain withdrawal record, the electronic device determines whether the withdrawal account and the bank account in the withdrawal record are stored correspondingly by searching among the stored withdrawal accounts and bank accounts; if the withdrawal account and the bank account in the withdrawal record are stored correspondingly, the electronic device determines that the bank account in the withdrawal record successfully matches the pre-stored audit rules. If the withdrawal account and the bank account in the withdrawal record are not stored correspondingly, the electronic device determines that the bank account in the withdrawal record fails to match the pre-stored audit rules.

In practice, virtual currency received by a user may be illegal. In order to determine whether the virtual currency received by the user is legal, the withdrawal data items in the withdrawal record may further include a duration of use of a network APP and a number of use of a network APP. It is determined whether the virtual currency received by the user is legal by determining whether both of the duration of use of a network APP and the number of use of a network APP successfully match the pre-stored audit rules.

A preset calculation model is run by taking the duration of use of a network APP and the number of use of a network APP as parameters, to obtain the calculated amount of virtual currency. It is determined whether the obtained calculated amount of virtual currency is larger than the accumulated amount of received virtual currency. If the obtained calculated amount of virtual currency is larger than the accumulated amount of received virtual currency, it is determined that both of the duration of use of a network APP and the number of use of a network APP successfully match the pre-stored audit rules. If the obtained calculated amount of virtual currency is not larger than the accumulated amount of received virtual currency, it is determined that both of the duration of use of a network APP and the number of use of a network APP fails to match the pre-stored audit rules.

Specifically, the electronic device may pre-create a calculation model for calculating the calculated amount of virtual currency. The calculation model uses the duration of use of a network APP and the number of use of a network APP as parameters, to characterize the maximum total amount of virtual currency possibly received by a user, in the case of a specific duration of use of a network APP and a specific number of use of a network APP.

After reading the duration of use of a network APP and the number of use of a network APP in a certain withdrawal record, the electronic device runs the preset calculation model by using the duration of use of a network APP and the number of use of a network APP as parameters, to obtain a calculated amount of virtual currency. The calculated amount of virtual currency is configured for characterizing the maximum total amount of virtual currency possibly received by a user.

It is determined whether the obtained calculated amount of virtual currency is larger than the accumulated amount of received virtual currency. If the obtained calculated amount of virtual currency is larger than the accumulated amount of received virtual currency, it is indicated that the total amount of virtual currency received currently by the user is not large, and thus the virtual currency received by the user is legal. At this time, it is determined that both of the duration of use of a network APP and the number of use of a network APP successfully match the pre-stored audit rules. If the obtained calculated amount of virtual currency is not larger than the accumulated amount of received virtual currency, it is indicated that the total amount of virtual currency received currently by the user is large, and thus the virtual currency received by the user is illegal. At this time, it is determined that both of the duration of use of a network APP and the number of use of a network APP fail to match the pre-stored audit rules.

In the embodiment, the calculation model may be trained and obtained by the existing recurrent neural network based on durations of use of a network APP, numbers of use of a network APP and the amount of received virtual currency by a lot of users when the users the network APP. The calculation model may be created based on empirical values, for example, the calculation model may be z=ax²+by², wherein, x is the duration of a network APP, y is the number of use of a network APP, a is a first-type empirical coefficient, b is a second-type empirical coefficient, and z is the calculated amount of virtual currency.

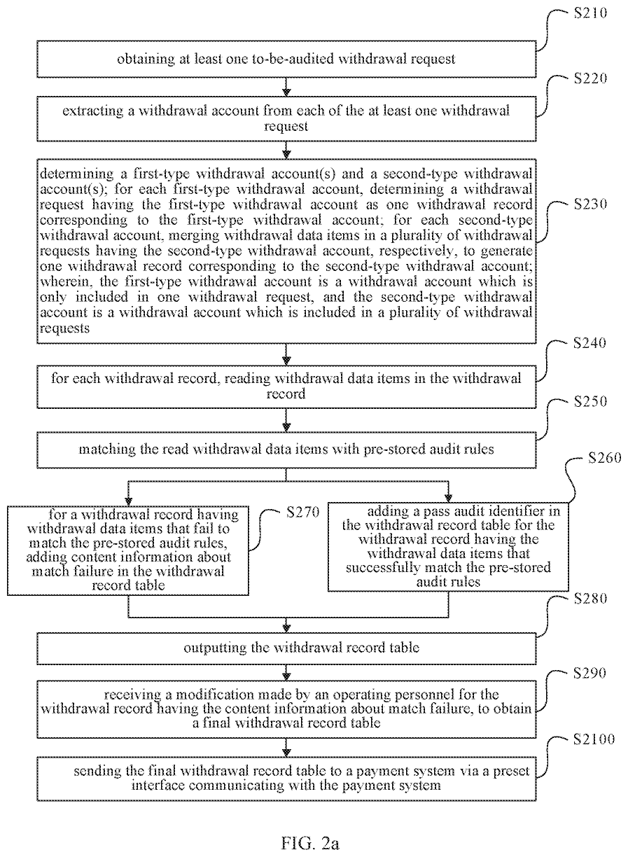

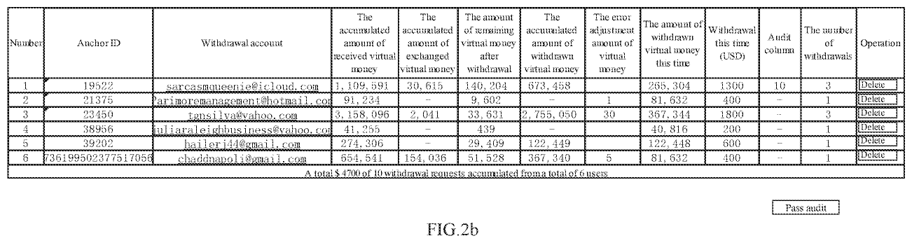

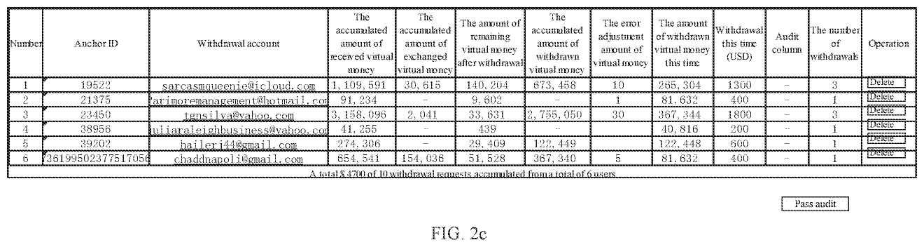

FIG. 2a is a second flowchart of a method for auditing a withdrawal request according to an embodiment of the present application. The method includes steps S210-S2100.

At S210, at least one to-be-audited withdrawal request is obtained.

At S220, a withdrawal account is extracted from each of the at least one withdrawal request.

At S230, one withdrawal record is generated for each withdrawal account; wherein, withdrawal data items in a plurality of withdrawal requests having the same withdrawal account are merged, respectively, to generate one withdrawal record.

At S240, for each withdrawal record, withdrawal data items in the withdrawal record are read.

At S250, the read withdrawal data items are matched with pre-stored audit rules.

In the embodiment, the content of the step S210 to step S250 described above is the same as the content of step S110 to step S150, which will be not described herein.

After the step S250, the electronic device performs the step of determining that a withdrawal record having withdrawal data items that successfully match the pre-stored audit rules passes audit. In a specific implementation of the embodiment of the present application, each generated withdrawal record is stored in a preset withdrawal record table. The step of determining that a withdrawal record having withdrawal data items that successfully match the pre-stored audit rules passes audit includes step S260.

At S260, for a withdrawal record having the withdrawal data items that successfully match the pre-stored audit rules, a pass audit identifier is added in a withdrawal record table.

Specifically, the electronic device may create a withdrawal record table. The withdrawal record table stores each generated withdrawal record. After matching the withdrawal data items in each withdrawal record with the pre-stored audit rules, the electronic device adds a pass audit identifier for a successfully matched withdrawal record in the withdrawal record table, to represent that the withdrawal record has passed the audit.

FIG. 2b is a first schematic diagram of the withdrawal record table used in the embodiment shown in FIG. 2a. The withdrawal record table includes a plurality of withdrawal records. The withdrawal data items in each of the plurality of withdrawal accounts include the withdrawal account, the accumulated amount of received virtual currency, the accumulated amount of exchanged virtual currency, the amount of remaining virtual currency after withdrawal, the accumulated amount of withdrawn virtual currency, the error adjustment amount of virtual currency and the amount of withdrawn virtual currency this time, and son. When each item of withdrawal data in a certain withdrawal record successfully matches the pre-stored audit rules, an identifier “-”, i.e. the pass audit identifier, will be added in an audit column.

In the embodiment, the withdrawal records may further include a withdrawal this time (USD). The withdrawal this time (USD) is obtained by exchanging the amount of withdrawn virtual currency this time into USD based on a preset exchange formula.

An error may present in the process of the electronic device auditing a withdrawal record (that is, in the case of some withdrawal data items in a withdrawal record failing to match the pre-stored audit rules). In order to further ensure the correctness of the audit process, in a specific implementation provided by an embodiment of the present application, as described in FIG. 2a, the method further includes steps S207-S209.

At S270, for a withdrawal record having the withdrawal data items that fail to match the pre-stored audit rules, content information about match failure is added in the withdrawal record table.

Specifically, an error may present in the process of the electronic device auditing a withdrawal record. As shown in FIG. 2, for the first withdrawal record, the sum of the accumulated amount of exchanged virtual currency, the amount of remaining virtual currency after withdrawal, the accumulated amount of withdrawn virtual currency, the error adjustment amount of virtual currency and the amount of withdrawn virtual currency this time is not equal to the accumulated amount of received virtual currency, and the difference between the sum and the accumulated amount of received virtual currency is 10. Therefore, 10 may be added in the audit column of the withdrawal record table as the content information about match failure.

At S280, the withdrawal record table is output.

Specifically, after obtaining both the withdrawal record including the pass audit identifier and the withdrawal record including the content information about match failure, the obtained withdrawal record table is output.

In the embodiment, the electronic device may be connected with at least one further device (for example, a computer). The electronic device sends the withdrawal record table to the further device, such that the further device displays the withdrawal record table.

At S290, a modification made by an operating personnel for a withdrawal record having the content information about match failure is received, to obtain a final withdrawal record table.

FIG. 2c is a second schematic diagram of the withdrawal record table used in the embodiment shown in FIG. 2a. The operating personnel of the network APP may make a corresponding modification in the column of the error adjustment amount of virtual currency, and the electronic device receives the modification. Taking the first withdrawal record as an example, the operating personnel modify content in the column of the error adjustment amount of virtual currency to 10. The electronic device receives the modification and detects that the sum of the accumulated amount of exchanged virtual currency, the amount of remaining virtual currency after withdrawal, the accumulated amount of withdrawn virtual currency, the error adjustment amount of virtual currency and the amount of withdrawn virtual currency this time is equal to the accumulated amount of received virtual currency, and then adds a pass audit identifier in the audit column to obtain the final withdrawal record table.

In other embodiments, the electronic device may also send a withdrawal record table that one operating personnel confirms that the withdrawal record has passed the audit to another device, to be audited again by another operating personnel, which ensures the correctness of the audit process.

At S2100, the final withdrawal record table is sent to a payment system via a preset interface communicating with the payment system.

Specifically, the electronic device is connected to the payment system via a corresponding communication interface. After obtaining the final withdrawal record table, the electronic device sends the withdrawal record table to the payment system via the interface, such that the payment system makes a payment to the user.

In the embodiment, the electronic device can be connected to the payment system, to implement a fast and safe payment operation, which shortens the time that the user waits for the payment and improving the user experience by being combined with a fast audit process.

In making a payment to a user practically, the payment system may not need all withdrawal data items in the withdrawal record. Therefore, in an implementation provided by the embodiment of the present application, the step of receiving a modification made by an operating personnel on a withdrawal record having the content information about match failure, to obtain a final withdrawal record table includes steps A1-A2.

At A1, the modification made by the operating personnel for the withdrawal record having the content information about match failure is received.

Specifically, the specific content of the step A1 may be referred to the step S290 described above, which will be not described herein.

At A2, withdrawal data required by the payment system is extracted from the modified withdrawal record table to generate the final withdrawal record table.

Specifically, in making a payment to a user practically, the payment system only needs the withdrawal this time (USD) and the bank account to implement the payment. Thus, the electronic device may extract the withdrawal this time (USD) and the bank account from the withdrawal record table to generate the final withdrawal record table, and send the same to the payment system to make a payment to the user.

In another implementation, the electronic device may be connected to a third device. After receiving the modification made by the operating personnel for the withdrawal record having the content information about match failure, the electronic device extracts the withdrawal account and the withdrawal this time (USD) from the modified withdrawal record table to generate a first-type withdrawal record table. Each withdrawal record in the first-type withdrawal record table is provided with a “Delete” button and a “Complete” button. The electronic device sends the first-type withdrawal record table to the third device. The operating personnel (which may be financial people) of the third device may click the “Delete” button of a certain withdrawal record to reject the withdrawal request, and the operating personnel may also click the “Complete” button to confirm that the withdrawal request passes the audit.

After the operating personnel completes the operations on all withdrawal records in the withdrawal record table, the electronic device generates a second-type withdrawal record table based on all the withdrawal requests that pass the audit and extracts withdrawal data required by the payment system from the second-type withdrawal record table to generate the final withdrawal record table, and sends the final withdrawal record table to the payment system, such that the payment system makes a payment to the user.

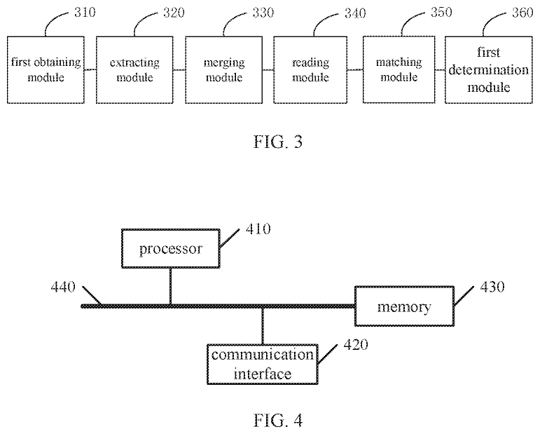

Corresponding to the above embodiment of the method, an embodiment of the present application further provides an apparatus for auditing a withdrawal request, which is applied to the electronic device. FIG. 3 is a schematic structural diagram of an apparatus for auditing a withdrawal request according to an embodiment of the present application. The apparatus includes:

a first obtaining module 310, configured for: obtaining at least one to-be-audited withdrawal request;

an extracting module 320, configured for: extracting a withdrawal account from each of the at least one withdrawal request;

a merging module 330, configured for: determining a first-type withdrawal account(s) and a second-type withdrawal account(s); for each first-type withdrawal account, determining a withdrawal request having the first-type withdrawal account as one withdrawal record corresponding to the first-type withdrawal account; for each second-type withdrawal account, merging withdrawal data items in a plurality of withdrawal requests having the second-type withdrawal account, respectively, to generate one withdrawal record corresponding to the second-type withdrawal account: wherein, the first-type withdrawal account is a withdrawal account which is only included in one withdrawal request, and the second-type withdrawal account is a withdrawal account which is included in a plurality of withdrawal requests;

a reading module 340, configured for: for each withdrawal record, reading withdrawal data items in the withdrawal record;

a matching module 350, configured for: matching the read withdrawal data items with pre-stored audit rules: and

a first determination module 360, configured for: determining that a withdrawal record having withdrawal data items that successfully match the pre-stored audit rules passes audit.

For the apparatus for auditing a withdrawal request provided by the embodiment of the present application, after obtaining at least one to-be-audited withdrawal request, the electronic device can merge the withdrawal requests having the same withdrawal account into one withdrawal record, which reduces the number of withdrawal requests that needs to be audited, implements batched audit of withdrawal requests, and thus reduces the workload of the operating personnel in the process of auditing withdrawal requests.

In a specific implementation provided by an embodiment of the present application, the obtaining module is further configured for: obtaining at least one to-be-audited withdrawal request that is received within a predetermined time period.

In a specific implementation provided by an embodiment of the present application, the apparatus further includes:

a second determination module, configured for: determining a withdrawal request with a withdrawal account containing a preset identifier as a first withdrawal request;

the merging module is further configured for: determining the first-type withdrawal account(s) and the second-type withdrawal account(s): for each first-type withdrawal account, determining a first withdrawal request having the first-type withdrawal account as one withdrawal record corresponding to the first-type withdrawal account: for each second-type withdrawal account, merging withdrawal data items in a plurality of first withdrawal requests having the second-type withdrawal account respectively, to generate one withdrawal record corresponding to the second-type withdrawal account.

In a specific implementation provided by an embodiment of the present application, the withdrawal data items include an amount of withdrawn virtual currency this time, an accumulated amount of received virtual currency, an accumulated amount of exchanged virtual currency, an amount of remaining virtual currency after withdrawal, an accumulated amount of withdrawn virtual currency and an error adjustment amount of virtual currency;

the reading module is further configured for: for each withdrawal record, reading the amount of withdrawn virtual currency this time, the accumulated amount of received virtual currency, the accumulated amount of exchanged virtual currency, the amount of remaining virtual currency after withdrawal, the accumulated amount of withdrawn virtual currency and the error adjustment amount of virtual currency in the withdrawal record;

the matching module includes:

a first judgment unit, configured for: determining whether the amount of withdrawn virtual currency this time is larger than a preset threshold amount of withdrawn virtual currency;

a first determining unit, configured for: when the first judgment unit determines that the amount of withdrawn virtual currency this time is not larger than the preset threshold amount of withdrawn virtual currency, determining that the amount of withdrawn virtual currency this time successfully matches the pre-stored audit rules:

a second determining unit, configured for: when the first judgment unit determines that the amount of withdrawn virtual currency this time is larger than the preset threshold amount of withdrawn virtual currency, determining that the amount of withdrawn virtual currency this time fails to match the pre-stored audit rules;

a summing unit, configured for: calculating a sum of the accumulated amount of exchanged virtual currency, the amount of remaining virtual currency after withdrawal, the accumulated amount of withdrawn virtual currency, the error adjustment amount of virtual currency and the amount of withdrawn virtual currency this time;

a second judgment unit, configured for: determining whether the sum is equal to the accumulated amount of received virtual currency;

a third determining unit, configured for: when the second judgment unit determines that the sum is equal to the accumulated amount of received virtual currency, determining that the accumulated amount of received virtual currency, the accumulated amount of exchanged virtual currency, the amount of remaining virtual currency after withdrawal, the accumulated amount of withdrawn virtual currency and the error adjustment amount of virtual currency successfully match with the pre-stored audit rules, respectively;

a fourth determining unit, configured for: when the second judgment unit determines that the sum is not equal to the accumulated amount of received virtual currency, determining that the accumulated amount of received virtual currency, the accumulated amount of exchanged virtual currency, the amount of remaining virtual currency after withdrawal, the accumulated amount of withdrawn virtual currency and the error adjustment amount of virtual currency fail to match the pre-stored audit rules respectively.

In a specific implementation provided by an embodiment of the present application, each generated withdrawal record is stored in a preset withdrawal record table;

the first determination module is further configured for: adding a pass audit identifier in the withdrawal record table for the withdrawal record having the withdrawal data items that successfully match the pre-stored audit rules.

In a specific implementation provided by an embodiment of the present application, the apparatus further includes:

an adding module, configured for: for a withdrawal record having withdrawal data items that fail to match the pre-stored audit rules, adding content information about match failure in the withdrawal record table;

an outputting module, configured for: outputting the withdrawal record table;

a second obtaining module, configured for: receiving a modification made by an operating personnel for the withdrawal record having the content information about match failure, to obtain a final withdrawal record table;

a sending module, configured for: sending the final withdrawal record table to a payment system via a preset interface communicating with the payment system.

In a specific implementation provided by an embodiment of the present application, the second obtaining module includes:

a receiving unit, configured for: receiving the modification made by the operating personnel for the withdrawal record having the content information about match failure:

an extracting unit, configured for: extracting the withdrawal data required by the payment system from the modified withdrawal record table to generate the final withdrawal record table.

Corresponding to the above embodiment of the method, an embodiment of the present application further provides an electronic device. FIG. 4 is a schematic structural diagram of an electronic device provided by an embodiment of the present application. The electronic device includes a processor 410, a communication interface 420, a memory 430 and a communication bus 440; wherein, the processor 410, the communication interface 420 and the memory 430 communicate with each other via the communication bus 440.

The memory 430 is configured for: storing a computer program.

The processor 410 is configured for: when executing the computer program stored in the memory 430, implementing the method for auditing a withdrawal request provided by the embodiment of the present application.

Specifically, the method for auditing a withdrawal request described above includes:

obtaining at least one to-be-audited withdrawal request;

extracting a withdrawal account from each of the at least one withdrawal request:

determining a first-type withdrawal account(s) and a second-type withdrawal account(s); for each first-type withdrawal account, determining a withdrawal request having the first-type withdrawal account as one withdrawal record corresponding to the first-type withdrawal account; for each second-type withdrawal account, merging withdrawal data items in a plurality of withdrawal requests having the second-type withdrawal account, respectively, to generate one withdrawal record corresponding to the second-type withdrawal account; wherein, the first-type withdrawal account is a withdrawal account which is only included in one withdrawal request, and the second-type withdrawal account is a withdrawal account which is included in a plurality of withdrawal requests;

for each withdrawal record, reading withdrawal data items in the withdrawal record;

matching the read withdrawal data items with pre-stored audit rules; and

determining that a withdrawal record having withdrawal data items that successfully match the pre-stored audit rules passes audit.

After obtaining at least one to-be-audited withdrawal request, the electronic device provided by the embodiment of the present application can merge the withdrawal requests having the same withdrawal account into one withdrawal record, which reduces the number of withdrawal requests that needs to be audited, implements batched audit of withdrawal requests, and thus reduces the workload of the operating personnel in the process of auditing withdrawal requests.

Other implementations of the method for auditing a withdrawal request described above are the same as those of the method for auditing a withdrawal request provided in the foregoing method embodiment, which will be not described herein.

The communication bus in the above electronic device may be a Peripheral Component Interconnect (PCI) bus or an Extended Industry Standard Architecture (EISA) bus, or the like. The communication bus may include an address bus, a data bus, a control bus, and the like. For ease of presentation, only one thick line is shown in the figure, which does not represent that there is only one communication bus or one type of communication bus.

The communication interface is configured for communication between the above electronic advice and other advices.

The memory may include a Random Access Memory (RAM), or may further include a Non-Volatile Memory (NVM), for example at least one disc memory. Optionally, the memory may further be a storage apparatus located away from the forgoing processor.

The above processor may be a general-purpose processor, including a Central Processing Unit (CPU), a Network Processor (NP), or the like; it may also be a Digital Signal Processor (DSP), an Application Specific Integrated Circuit (ASIC), a Field-Programmable Gate Array (FPGA) or other programmable logic equipment, a discrete gate or transistor logic equipment, a discrete hardware component.

Corresponding to the above embodiment of the method, an embodiment of the present application further provides a computer-readable storage medium. The computer-readable storage medium stores a computer program therein, and the computer program, when executed by the processor, implements the method for auditing a withdrawal request provided by the embodiment of the present application.

Specifically, the above method for auditing a withdrawal request includes:

obtaining at least one to-be-audited withdrawal request:

extracting a withdrawal account from each of the at least one withdrawal request:

determining a first-type withdrawal account(s) and a second-type withdrawal account(s); for each first-type withdrawal account, determining a withdrawal request having the first-type withdrawal account as one withdrawal record corresponding to the first-type withdrawal account; for each second-type withdrawal account, merging withdrawal data items in a plurality of withdrawal requests having the second-type withdrawal account, respectively, to generate one withdrawal record corresponding to the second-type withdrawal account; wherein, the first-type withdrawal account is a withdrawal account which is only included in one withdrawal request, and the second-type withdrawal account is a withdrawal account which is included in a plurality of withdrawal requests:

for each withdrawal record, reading withdrawal data items in the withdrawal record;

matching the read withdrawal data items with pre-stored audit rules; and

determining that a withdrawal record having withdrawal data items that successfully match the pre-stored audit rules passes audit.

When the computer program stored in the storage medium provided by the embodiment of the present application is executed, after obtaining at least one to-be-audited withdrawal request, the electronic device can merge withdrawal requests having the same withdrawal account into one withdrawal record, which reduces the number of withdrawal requests that needs to be audited, implements batched audit of withdrawal requests, and thus reduces the workload of the operating personnel in the process of auditing withdrawal requests.

An embodiment of the present application further provides a computer program product including instructions. The computer program product is executed by an electronic device, so as to cause the electronic device to perform the steps of the above any one method for auditing a withdrawal request.

When the computer program product, including instructions, provided by the embodiment of the present application is executed by the electronic device, after obtaining at least one to-be-audited withdrawal request, the electronic device can merge withdrawal requests having the same withdrawal account into one withdrawal record, which reduces the number of withdrawal requests that needs to be audited, implements batched audit of withdrawal requests, and thus reduces the workload of the operating personnel in the process of auditing withdrawal requests.

Other implementations of the method for auditing a withdrawal request described above are the same as those of the method for auditing a withdrawal request provided in the foregoing method embodiment, which will be not described herein.

It should be noted that the relationship terms used herein, such as “first”, “second” and the like are only to distinguish one entity or operation from another entity or operation, but do not necessarily require or imply that there is any actual relationship or order between these entities or operations. Moreover, the terms “include”, “comprise”, or any other variants thereof are intended to cover a non-exclusive inclusion, such that processes, methods, articles or devices, including a series of elements, include not only those elements that have been listed, but also other elements that are not specifically listed or the elements intrinsic to these processes, methods, articles or devices. Without further limitations, elements defined by the wording “include(s) a/an . . . ” or “comprise(s) a/an . . . ” do not exclude additional identical elements in the processes, methods, articles, or devices that includes the listed elements.

All of the embodiments in the description are described in a correlated manner, and identical or similar parts in various embodiments can refer to one another. In addition, the description for each embodiment focuses on the differences from other embodiments. In particular, the embodiments of the apparatus, the electronic device and the storage medium are described briefly, since they are substantially similar to the embodiment of the method, and the related contents can refer to the description of the embodiment of the method.

The above embodiments are simply preferable embodiments of the present application, and are not intended to limit the scope of protection of the present application. Any modifications, equivalent alternatives, improvements, or the like within the spirit and principle of the present application shall be included within the scope of protection of the present application.

1. A method for auditing a withdrawal request, which is applied to an electronic device, comprising:
obtaining at least one to-be-audited withdrawal request;
extracting a withdrawal account from each of the at least one withdrawal request;
determining a first-type withdrawal account(s) and a second-type withdrawal account(s);
for each first-type withdrawal account, determining a withdrawal request having the first-type withdrawal account as one withdrawal record corresponding to the first-type withdrawal account;
for each second-type withdrawal account, merging withdrawal data items in a plurality of withdrawal requests having the second-type withdrawal account, respectively, to generate one withdrawal record corresponding to the second-type withdrawal account;
for each withdrawal record, reading withdrawal data items in the withdrawal record;
matching the read withdrawal data items with pre-stored audit rules; and
determining that a withdrawal record having withdrawal data items that successfully match the pre-stored audit rules passes audit;
wherein, the first-type withdrawal account is a withdrawal account which is only included in one withdrawal request, and the second-type withdrawal account is a withdrawal account which is included in a plurality of withdrawal requests.

2. The method of claim 1, wherein obtaining at least one to-be-audited withdrawal request comprises:
obtaining at least one to-be-audited withdrawal request that is received within a predetermined time period.

3. The method of claim 1, wherein, after extracting the withdrawal account from each of the at least one withdrawal request and before determining the first-type withdrawal account(s) and the second-type withdrawal account(s), the method further comprises:
determining a withdrawal request with a withdrawal account containing a preset identifier as a first withdrawal request;
the step of: for each first-type withdrawal account, determining a withdrawal request having the first-type withdrawal account as one withdrawal record corresponding to the first-type withdrawal account; for each second-type withdrawal account, merging withdrawal data items in a plurality of withdrawal requests having the second-type withdrawal account respectively, to generate one withdrawal record corresponding to the second-type withdrawal account, comprises:
for each first-type withdrawal account, determining a first withdrawal request having the first-type withdrawal account as one withdrawal record corresponding to the first-type withdrawal account; for each second-type withdrawal account, merging withdrawal data items in a plurality of first withdrawal requests having the second-type withdrawal account respectively, to generate one withdrawal record corresponding to the second-type withdrawal account.

4. The method of claim 1, wherein, the withdrawal data items comprise an amount of withdrawn virtual currency this time, an accumulated amount of received virtual currency, an accumulated amount of exchanged virtual currency, an amount of remaining virtual currency after withdrawal, an accumulated amount of withdrawn virtual currency and an error adjustment amount of virtual currency;
the step of: for each withdrawal record, reading withdrawal data items in the withdrawal record comprises:
for each withdrawal record, reading the amount of withdrawn virtual currency this time, the accumulated amount of received virtual currency, the accumulated amount of exchanged virtual currency, the amount of remaining virtual currency after withdrawal, the accumulated amount of withdrawn virtual currency and the error adjustment amount of virtual currency in the withdrawal record;
the step of matching the read withdrawal data items with pre-stored audit rules comprises:
determining whether the amount of withdrawn virtual currency this time is larger than a preset threshold amount of withdrawn virtual currency;
if the amount of withdrawn virtual currency this time is not larger than the preset threshold amount of withdrawn virtual currency, determining that the amount of withdrawn virtual currency this time successfully matches the pre-stored audit rules;
if the amount of withdrawn virtual currency this time is larger than the preset threshold amount of withdrawn virtual currency, determining that the amount of withdrawn virtual currency this time fails to match the pre-stored audit rules;
calculating a sum of the accumulated amount of exchanged virtual currency, the amount of remaining virtual currency after withdrawal, the accumulated amount of withdrawn virtual currency, the error adjustment amount of virtual currency and the amount of withdrawn virtual currency this time;
determining whether the sum is equal to the accumulated amount of received virtual currency;
if the sum is equal to the accumulated amount of received virtual currency, determining that the accumulated amount of received virtual currency, the accumulated amount of exchanged virtual currency, the amount of remaining virtual currency after withdrawal, the accumulated amount of withdrawn virtual currency and the error adjustment amount of virtual currency successfully match with the pre-stored audit rules, respectively;
if the sum is not equal to the accumulated amount of received virtual currency, determining that the accumulated amount of received virtual currency, the accumulated amount of exchanged virtual currency, the amount of remaining virtual currency after withdrawal, the accumulated amount of withdrawn virtual currency and the error adjustment amount of virtual currency fail to match the pre-stored audit rules respectively.

5. The method of claim 1, wherein, each generated withdrawal record is stored in a preset withdrawal record table;
the step of determining that a withdrawal record having withdrawal data items that successfully match the pre-stored audit rules passes audit comprises:
adding a pass audit identifier in the withdrawal record table for the withdrawal record having the withdrawal data items that successfully match the pre-stored audit rules.

6. The method of claim 5, wherein, after matching the read withdrawal data items with the pre-stored audit rules, the method further comprises:
for a withdrawal record having withdrawal data items that fail to match the pre-stored audit rules, adding content information about match failure in the withdrawal record table;
outputting the withdrawal record table;
receiving a modification made by an operating personnel for the withdrawal record having the content information about match failure, to obtain a final withdrawal record table;
sending the final withdrawal record table to a payment system via a preset interface communicating with the payment system.

7. The method of claim 6, wherein, the step of receiving a modification made by an operating personnel for the withdrawal record having the content information about match failure, to obtain a final withdrawal record table comprises:
receiving the modification made by the operating personnel for the withdrawal record having the content information about match failure;
extracting the withdrawal data required by the payment system from the modified withdrawal record table to generate the final withdrawal record table.

8. An apparatus for auditing a withdrawal request, which is applied to an electronic device, comprising:
a first obtaining module, configured for obtaining at least one to-be-audited withdrawal request;
an extracting module, configured for extracting a withdrawal account from each of the at least one withdrawal request;
a merging module, configured for determining a first-type withdrawal account(s) and a second-type withdrawal account(s); for each first-type withdrawal account, determining a withdrawal request having the first-type withdrawal account as one withdrawal record corresponding to the first-type withdrawal account; for each second-type withdrawal account, merging withdrawal data items in a plurality of withdrawal requests having the second-type withdrawal account, respectively, to generate one withdrawal record corresponding to the second-type withdrawal account; wherein, the first-type withdrawal account is a withdrawal account which is only included in one withdrawal request, and the second-type withdrawal account is a withdrawal account which is included in a plurality of withdrawal requests;
a reading module, configured for each withdrawal record, reading withdrawal data items in the withdrawal record;
a matching module, configured for matching the read withdrawal data items with pre-stored audit rules; and
a first determination module, configured for determining that a withdrawal record having withdrawal data items that successfully match the pre-stored audit rules passes audit.

9. The apparatus of claim 8, wherein,
the obtaining module is further configured for obtaining at least one to-be-audited withdrawal request that is received within a predetermined time period.

10. The apparatus of claim 8, wherein, the apparatus further comprises:
a second determination module, configured for determining a withdrawal request with a withdrawal account containing a preset identifier as a first withdrawal request;
the merging module is further configured for determining the first-type withdrawal account(s) and the second-type withdrawal account(s); for each first-type withdrawal account, determining a first withdrawal request having the first-type withdrawal account as one withdrawal record corresponding to the first-type withdrawal account; for each second-type withdrawal account, merging withdrawal data items in a plurality of first withdrawal requests having the second-type withdrawal account respectively, to generate one withdrawal record corresponding to the second-type withdrawal account.

11. The apparatus of claim 8, wherein, the withdrawal data items comprise an amount of withdrawn virtual currency this time, an accumulated amount of received virtual currency, an accumulated amount of exchanged virtual currency, an amount of remaining virtual currency after withdrawal, an accumulated amount of withdrawn virtual currency and an error adjustment amount of virtual currency;
the reading module is further configured for each withdrawal record, reading the amount of withdrawn virtual currency this time, the accumulated amount of received virtual currency, the accumulated amount of exchanged virtual currency, the amount of remaining virtual currency after withdrawal, the accumulated amount of withdrawn virtual currency and the error adjustment amount of virtual currency in the withdrawal record;
the matching module comprises:
a first judgment unit, configured for determining whether the amount of withdrawn virtual currency this time is larger than a preset threshold amount of withdrawn virtual currency;
a first determining unit, configured for when the first judgment unit determines that the amount of withdrawn virtual currency this time is not larger than the preset threshold amount of withdrawn virtual currency, determining that the amount of withdrawn virtual currency this time successfully matches the pre-stored audit rules;
a second determining unit, configured for when the first judgment unit determines that the amount of withdrawn virtual currency this time is larger than the preset threshold amount of withdrawn virtual currency, determining that the amount of withdrawn virtual currency this time fails to match the pre-stored audit rules;
a summing unit, configured for calculating a sum of the accumulated amount of exchanged virtual currency, the amount of remaining virtual currency after withdrawal, the accumulated amount of withdrawn virtual currency, the error adjustment amount of virtual currency and the amount of withdrawn virtual currency this time;
a second judgment unit, configured for determining whether the sum is equal to the accumulated amount of received virtual currency;
a third determining unit, configured for when the second judgment unit determines that the sum is equal to the accumulated amount of received virtual currency, determining that the accumulated amount of received virtual currency, the accumulated amount of exchanged virtual currency, the amount of remaining virtual currency after withdrawal, the accumulated amount of withdrawn virtual currency and the error adjustment amount of virtual currency successfully match with the pre-stored audit rules, respectively;
a fourth determining unit, configured for when the second judgment unit determines that the sum is not equal to the accumulated amount of received virtual currency, determining that the accumulated amount of received virtual currency, the accumulated amount of exchanged virtual currency, the amount of remaining virtual currency after withdrawal, the accumulated amount of withdrawn virtual currency and the error adjustment amount of virtual currency fail to match the pre-stored audit rules respectively.

12. The apparatus of claim 8, wherein, each generated withdrawal record is stored in a preset withdrawal record table;
the first determination module is further configured for adding a pass audit identifier in the withdrawal record table for the withdrawal record having the withdrawal data items that successfully match the pre-stored audit rules.

13. The apparatus of claim 12, wherein, the apparatus further comprises:
an adding module, configured for a withdrawal record having withdrawal data items that fail to match the pre-stored audit rules, adding content information about match failure in the withdrawal record table;
an outputting module, configured for outputting the withdrawal record table;
a second obtaining module, configured for receiving a modification made by an operating personnel for the withdrawal record having the content information about match failure, to obtain a final withdrawal record table;
a sending module, configured for sending the final withdrawal record table to a payment system via a preset interface communicating with the payment system.

14. The apparatus of claim 13, wherein, the second obtaining module comprises:
a receiving unit, configured for receiving the modification made by the operating personnel for the withdrawal record having the content information about match failure;
an extracting unit, configured for extracting the withdrawal data required by the payment system from the modified withdrawal record table to generate the final withdrawal record table.

15. An electronic device, comprising: a processor, a communication interface, a memory and a communication bus; wherein, the processor, the communication interface and the memory communicate with each other via the communication bus;
the memory is configured for storing a computer program; and
the processor is configured for when executing the computer program stored in the memory, implementing the method of claim 1.

16. A non-transitory computer-readable storage medium, which stores a computer program therein; wherein, the computer program, when executed by a processor, implements the method of claim 1.

17. (canceled)
